(19) United States
(12) Patent Application Publication
(10) Pub. No.: US 2007/0228848 A1
(43) Pub. Date: Oct. 4, 2007

(54) STATOR FOR AN ELECTRICAL MACHINE

(76) Inventors: Juergen Wiker, Hangzhou/Bing (CN); Ralph Dammertz, (US)

Correspondence Address: Striker, Striker & Stenby, 103 East Neck Road, Huntington, NY, 11743, US

(21) Appl. No.: 11/624,859

(22) Filed: Jan. 19, 2007

(30) Foreign Application Priority Data
Mar. 29, 2006 (DE) 102006014498.8

(51) Int. Cl. H02K 9/00; H02K 3/24; H02K 23/04

(52) U.S. Cl. 310/64; 310/52; 310/154.08; 310/254

(57) ABSTRACT

A stator for an electrical machine includes a flux return ring, a stator winding, and stator teeth located equidistantly along the flux return ring for accommodating the stator winding, wherein the flux return ring includes cooling elements.

### CROSS-REFERENCE TO A RELATED APPLICATION

The invention described and claimed hereinbelow is also described in German Patent Application No. DE 10 2006 014 498.8, filed Mar. 29, 2006. This German Patent Application, whose subject matter is incorporated here by reference, provides the basis for a claim of priority of invention under 35 U.S.C. 119 (a)-(d).

### BACKGROUND OF THE INVENTION

The present invention relates to a stator for an electrical machine, in particular for a universal motor.

Universal motors are used widely, e.g, in power tools. Since, with universal motors, electric current flows through the armature winding and the excitation winding, a great deal of heat is produced, which gradually heats up the entire motor. To prevent damage that could be caused by the motor heating up, it must be ensured that the motor is cooled adequately. With power tools, air is drawn in from the outside, e.g., through a fan wheel, for cooling, as described, e.g., in DE 102 56 805 A. The fan wheel is mounted non-rotatably on the armature shaft between the armature and gearbox. When the fan wheel rotates, it generates an air flow which flows axially through the power tool and carries heat to the outside.

To achieve good cooling, as much air as possible must be transported through the power tool. High air throughput means a high flow rate, however, which can be associated with undesired fan noises under certain circumstances. In addition, when the cooling air flows through the power tool, it only passes over the surface of the armature and the stator. With universal motors with a small armature diameter in particular, the surface of the armature and the stator is correspondingly small. As a result, only a relatively small amount of heat can be dissipated to the cooling air by the armature and the stator. Cooling using a fan wheel is therefore inadequate.

### SUMMARY OF THE INVENTION

Accordingly, it is an object of the present invention to provide a stator for an electrical machine, which avoids the disadvantages of the prior art.

More particulary, it is an object of the present invention to provide a stator for an electrical machine which has the advantage that more heat is carried away from the stator.

This is accomplished, according to the present invention, using cooling elements provided on the flux return ring of the stator. The surface of the stator is enlarged by the cooling elements, thereby enabling more heat to be dissipated. As a result of the increased heat dissipation, higher motor output is attained with the same volume of air which flows through the electrical machine with the aid of a fan wheel.

The inventive stator includes a flux return ring. The flux return ring is a hollow cylindrical carrier with an, e.g., round cross section. The flux return ring can also have one or more flat areas. The flux return ring can be, e.g., a component of the housing of the electrical machine. The flux return ring has several surfaces, i.e., an inner surface, an outer surface, and two end faces.

Stator teeth for accommodating a stator winding are located equidistantly along the flux return ring. For a two-pole motor, e.g., two stator teeth are located diametrally. The stator teeth can be designed as a single piece with the flux return ring. As an alternative, the stator teeth can also be connected individually with the flux return ring in a magnetically conductive manner, e.g., via welding or bonding. The stator teeth and the flux return ring are designed as a laminated core, or they are manufactured as a single component made of a soft-magnetic material, e.g., a SMC (soft magnetic composite) material. For an inner-rotor machine, the stator teeth are located on the inside surface of the flux return ring.

The individual, insulated stator teeth are each enveloped by a toroidal coil, which is wound with a winding wire in several layers around the neck of a stator tooth.

The inventive stator is suited for an inner-rotor machine and for an outer-rotor machine. The descriptions below are related to a stator for an inner-rotor machine.

According to the present invention, the flux return ring of the stator includes cooling elements. The cooling elements are preferably designed as axially-positioned cooling fins. The cooling fins can have any type of cross section, e.g., rectangular, triangular, or undulating. Instead of cooling fins, other geometric forms can be selected for use as cooling elements, such as pins, pegs, nubs, or the like. It is decisive that the cooling elements serve to enlarge the surfaces of the flux return ring. The shape and number of the cooling elements are therefore selected such that they increase the size of the surfaces to the greatest extent possible.

According to the present invention, the cooling elements can be provided on one or several surfaces of the flux return ring.

In a first embodiment, the cooling elements are located on the inside surface of the flux return ring. Since, with a stator for an inner-rotor machine, the stator teeth are also located on the inner surface of the flux return ring, cooling elements on the inner surface are located between two adjacent stator teeth in particular.

In a second embodiment, cooling elements are located on the outer surface of the flux return ring. Since, with a stator for an inner-rotor machine, the stator teeth are located on the inner surface of the flux return ring, it is possible to provide cooling elements on the entire outer surface of the flux return ring. The cooling elements can also be provided in only one or in several areas of the outer surface.

In a third embodiment, cooling elements are located on at least one of the two end faces of the flux return ring. Cooling elements can be located on the entire end face of the flux return ring, or in one or several areas. Depending on the cross section of the flux return ring, the end faces form, e.g., an annular surface. The cooling elements are positioned perpendicularly on the end faces, so that they extend over the flux return ring in the axial direction.

The three embodiments of cooling elements described can also be used in combination. For example, cooling elements can be located on the inner surface and on the outer surface.

Independent of the embodiment, the cooling elements can be designed as a single piece with the flux return ring, or they can be connected, as a separate component, with the flux return ring in a thermally conductive manner, e.g., using screws, or via bonding, welding or pressing. If the cooling elements—axially-positioned cooling fins, in particular—are a separate component, the cooling elements are connected with each other. For the inner surface or the outer surface of the flux return ring, the cooling elements are formed, e.g., by a flat carrier, on the surface of which fins are located. To ensure that a carrier of this type with cooling fins bears against the inner surface or outer surface of the flux return ring, the carrier is curved to match the inner diameter or outer diameter of the flux return ring.

Analogous to a stator described above for an inner-rotor machine, the cooling elements for a stator for an outer-rotor machine can also be provided on the inner surface, the outer surface, and/or on one of the two end faces, with the difference being that the stator teeth are located on the outer surface. Analogous to the inner surface of the stator described above, it is therefore not necessary to provide the entire outer surface with cooling elements, but only the areas between the stator teeth. It is possible, however, to equip the entire inner surface or only areas of the inner surface with cooling elements.

The stator is suited for use with a universal motor, in particular. The universal motor can be used, e.g., in a power tool.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a universal motor according to the related art, in a longitudinal sectional view

FIG. 2 shows a universal motor with an inventive stator in a first embodiment, in a cross section

FIG. 3 shows a second embodiment of the inventive stator, in a perspective view

FIG. 4 shows a third embodiment of the inventive stator, in a perspective view.

### DESCRIPTION OF THE PREFERRED EMBODIMENTS

FIG. 1 shows a universal motor 10 according to the related art, in a longitudinal sectional view. Only those components of universal motor 10 which are essential to the present invention will be described below. Universal motor 10 includes a housing 20 in which a stator 30 is non-rotatably located. An armature 40 with armature teeth 44 and armature grooves 42 located between them for accommodating an armature winding (not shown) is non-rotatably mounted on an armature shaft 22.

A commutator 25 is also mounted non-rotatably on armature shaft 22, on an end face of armature 40. A fan wheel 60 for cooling universal motor 10 is also mounted non-rotatably on armature shaft 22, on the other end face of armature 40. The fan wheel includes fan impellers 62 which face armature 40. To produce an axial air flow (indicated via arrow 64 in FIG. 1) in universal motor 10, inlet openings 24 are provided in housing 20 near the end face opposite fan wheel 60, and outlet openings 26 are provided near the end face of armature 40 facing fan wheel 60.

When fan wheel 60 rotates, air (indicated via arrow 65 in FIG. 1) is drawn into housing 20 from the outside through inlet openings 24, and it is blown out of housing 20 through outlet openings 26 (indicated via arrow 66 in FIG. 1). Axial air flow 64 flows through stator 30 and air gap 28 between stator 30 and armature 40. The cooling air flows along the surface of armature 40.

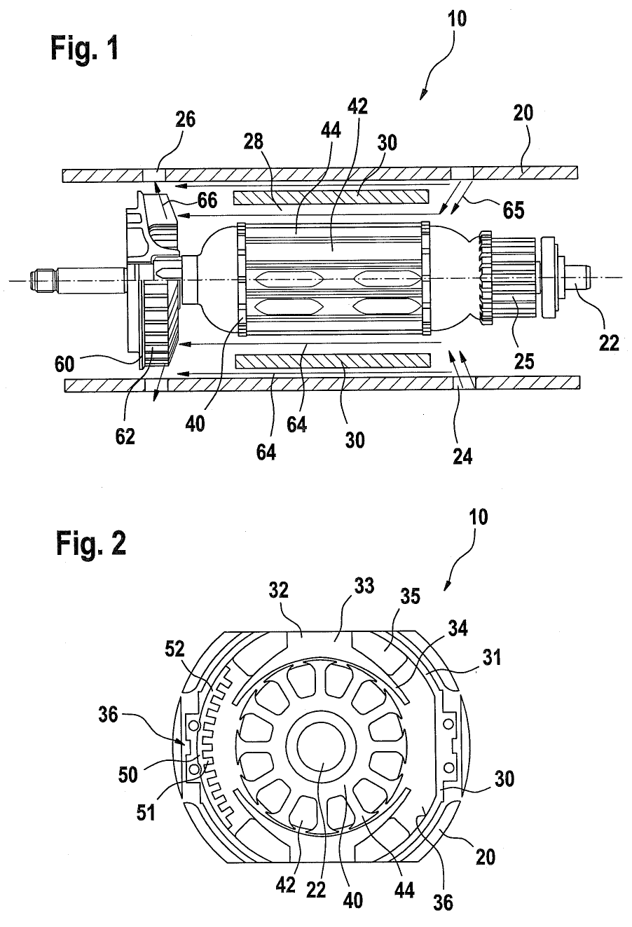

FIG. 2 shows a cross section of universal motor 10 with a first embodiment of inventive stator 30. A fixed stator 30 is located in housing 20. A non-rotatably supported armature 40 with armature teeth 44 and armature grooves 42 located between them is located in stator 30. Stator 30 depicted in FIG. 2 includes a flux return ring 31 and two inner, diametrally located stator teeth 32. Stator teeth 32 are composed of tooth necks 33 and tooth heads 34. A stator winding 35 in the form of a toroidal coil is wound around tooth necks 33.

Cooling elements 50 in the form of cooling fins 51 are provided on inner surface 36 of flux return ring 31. Cooling fins 51 have a rectangular cross section and are positioned axially. They extend from the surface of a flat carrier 52. Flat carrier 52 is mounted via its entire surface on inner surface 36 of flux return ring 31 and is therefore curved to match the inner diameter of flux return ring 31. Carrier 52 is connected in a thermally conductive manner with flux return ring 31 in a central region 36 of flux return ring 31 between the two stator teeth 32. This is accomplished via pressing, bonding, etc.

In FIG. 2, cooling elements 50 are provided only in a region of inner surface (shown at the left in FIG. 2) between the two stator teeth 32. As an alternative or in addition, cooling elements 50 can also be provided in the other region (shown at the right in FIG. 2) between the two stator teeth 32.

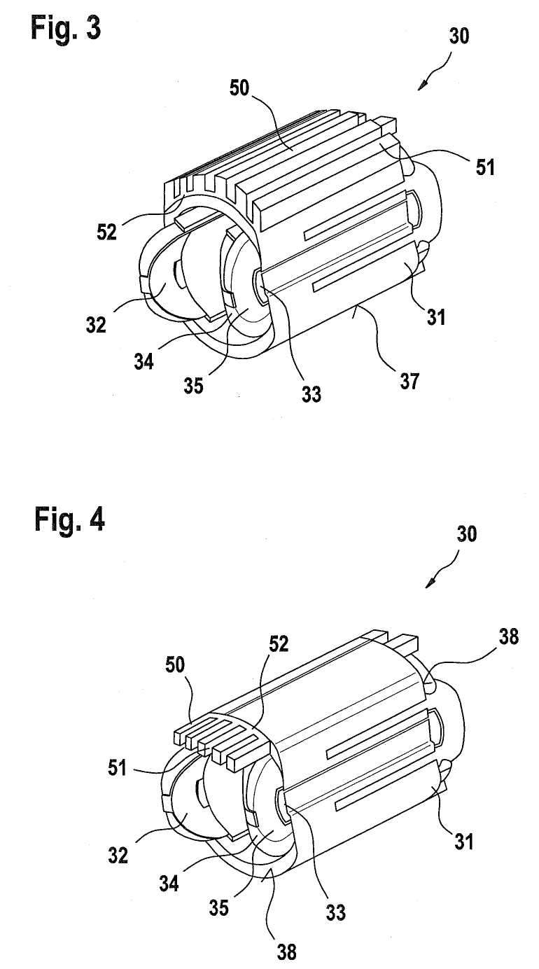

FIG. 3 shows a second embodiment of inventive stator 30. Stator 30 has two diametrally located, inner stator teeth 32, on each of which a toroidal coil, as armature winding 35, is mounted. Flux return ring 31 has cooling elements 50—in the form of cooling fins 51—mounted on its outer surface 37, which project from the surface of a flat carrier 52. Cooling fins 51 have a rectangular cross section in the embodiment depicted in FIG. 2. They are also positioned axially. Carrier 52 is mounted via its entire surface on outer surface 37 of flux return ring 31. To this end, carrier 52 is designed with curvature which matches the outer diameter of flux return ring 31. The thermally conductive connection of cooling elements 50 with flux return ring 31 can take place, e.g., via pressing, bonding, etc.

In FIG. 3, cooling elements 50 are provided only in a region of outer surface 37 (shown in the top region of outer surface 37 in FIG. 3). As an alternative or in addition, cooling elements 50 can also be provided in other regions of outer surface 37 or on entire outer surface 37.

FIG. 4 shows a third embodiment of inventive stator 30. Stator 30 also has two diametrally located, inner stator teeth 32, on each of which a toroidal coil, as armature winding 35, is mounted. Flux return ring 31 has two diametrically opposed end faces 38. End face 38 which points toward the front in FIG. 4 is provided with cooling elements 50 in the form of cooling fins 51. Cooling fins 31 are essentially orthogonal to end face 38 and therefore extend over flux return ring 31 in the axial direction. Cooling fins 31 are connected via a carrier 52 in a thermally conductive manner with end face 38 of flux return ring 31. To ensure that carrier 52 can bear against end face 38 and does not extend over end face 38, it is curved to match the curvature of flux return ring 31.

In FIG. 4, cooling elements 50 are provided only on one of the two end faces 38, and only in one region of these end faces 38 (shown in the top region of front end face 38 in FIG. 3). As an alternative or in addition thereto, cooling elements 50 can be provided on other regions of end faces 38 or on entire end face 38. Cooling elements 50 can also be provided on the other, diametrically opposed end face 38. It will be understood that each of the elements described above, or two or more together, may also find a useful application in other types of constructions differing from the types described above.

While the invention has been illustrated and described as embodied in a stator for an electrical machine, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A stator for an electrical machine, comprising a flux return ring; a stator winding; stator teeth located equidistantly along said flux return ring for accommodating said stator winding, wherein said flux return ring includes cooling elements.

2. A stator as defined in claim 1, wherein said flux return ring has an inner surface, said cooling elements being provided on said inner surface of said flux return ring.

3. A stator as defined in claim 2, wherein said cooling elements are located on said inner surface of said flux return ring between two adjacent ones of said stator teeth.

4. A stator as defined in claim 1, wherein said flux return ring has an outer surface, said cooling elements being provided on said outer surface of said flux return ring.

5. A stator as defined in claim 1, wherein said flux return ring has at least one end face, said cooling elements being provided on said at least one end face of the flux return ring.

6. A stator as defined in claim 1, wherein said cooling elements of said flux return ring are configured as cooling fins.

7. A stator as defined in claim 6, wherein said cooling fins of said flux return ring are positioned axially.

8. A universal motor, comprising a stator, said stator including a flux return ring, a stator winding, stator teeth located equidistantly along said flux return ring for accommodating said stator winding, wherein said flux return ring includes cooling elements.
